(19) United States
(12) Patent Application Publication
(10) Pub. No.: US 2016/0320900 A1
(43) Pub. Date: Nov. 3, 2016

(54) OPERATING DEVICE

(71) Applicant: KABUSHIKI KAISHA TOKAI RIKA DENKI SEISAKUSHO, Aichi (JP)

(72) Inventor: Yoshiaki NABE, Aichi (JP)

(21) Appl. No.: 15/108,147

(22) PCT Filed: Nov. 18, 2014
(86) PCT No.: PCT/JP2014/080507

§ 371 Date: Jun. 24, 2016

(30) Foreign Application Priority Data
Jan. 6, 2014 (JP) 2014-000288

(51) Int. Cl. G06F 3/041; H04M 1/725; H04L 29/08; B60K 35/00; B60K 37/04

(52) U.S. Cl. CPC G06F 3/0416; B60K 35/00; B60K 37/04; H04L 67/12; H04M 1/72527; B60K 2350/1024; B60K 2350/355; B60K 2350/928; B60K 2350/1068; B60K 2350/352

(57) ABSTRACT

An operating device includes: a communication unit that performs communication with an electronic device as the object of operation; a display control unit that acquires, via the communication unit, a first display image displayed by the electronic device, and that outputs, to a display device mounted on a vehicle, display control information for displaying a second display image based on the acquired first display image; an operation detection unit that is disposed on a steering wheel of the vehicle and that outputs detection information based on detection of an operation performed on an operation plane; and a control unit that generates operation information on the basis of the detection information acquired from the operation detection unit and that outputs the operation information to the electronic device.

### TECHNICAL FIELD

The present invention relates to an operating device that is installed in a vehicle or the like for operating an electronic device such as a mobile terminal while communicating with that electronic device.

### BACKGROUND ART

An on-vehicle machine including communication means that communicates with a mobile terminal, a touch panel that is installed in a dashboard (instrument panel) and is capable of accepting touch operations made by a user, and control means that, in the case where a touch operation on a first image displayed in the touch panel using image data received from the mobile terminal has been accepted while the first image is displayed, displays, in the touch panel, a second image that is an enlargement of a portion of the first image corresponding to a predetermined region containing coordinates of the touched position, and in the case where a touch operation on the second image displayed in the touch panel has been accepted, converts coordinates of the touched position in the second image into corresponding coordinates of a corresponding position in the first image and sends data regarding the corresponding coordinates to the mobile terminal, is known (see e.g. PTL 1).

This on-vehicle machine is configured so that, for example, in the case where several types of buttons are arranged close together in the first image and a touch operation on the first image has been accepted, the second image that is an enlargement of the portion corresponding to the predetermined region including the coordinates of the touched position is displayed in the touch panel, and further touch operations can be accepted for the buttons; this makes it possible to prevent the user from making mistaken presses.

### CITATION LIST

### Patent Literature

### SUMMARY OF INVENTION

### Technical Problem

The conventional on-vehicle machine sends the coordinates of the touch operation made on the enlarged second image to the mobile terminal, and thus it has been necessary to make at least two touch operations to operate the desired button; furthermore, because the touch panel is distanced from the steering wheel, it has been necessary to remove one's hand from the steering wheel to operate the touch panel, and thus the operability has been poor.

It is an object of the invention to provide an operating device that improves operability when operating an electronic device such as a mobile terminal while communicating with the electronic device.

### Solution to Problem

According to an embodiment of the invention, an operating device comprises:
a communicator that communicates with an electronic device serving as an operation target;
a display controller that obtains a first display image displayed by the electronic device through the communicator and outputs, to a display device installed in a vehicle, display control information that causes a second display image based on the obtained first display image to be displayed;
an operation detector disposed in a steering wheel of the vehicle, the operation detector being configured to output a detection information based on a detection of an operation made on an operating surface thereof; and
a controller that generates an operation information on the basis of the detection information obtained from the operation detector and outputs the operation information to the electronic device.

### Advantageous Effects of Invention

According to an embodiment of the invention, an operating device can be provided that improves operability when operating an electronic device such as a mobile terminal while communicating with the electronic device.

### BRIEF DESCRIPTION OF DRAWINGS

FIG. 1A is a schematic diagram illustrating the interior of a vehicle in which an operating device according to an embodiment is installed.

FIG. 1B is a schematic diagram illustrating an operator operating the operating device.

FIG. 2A is a block diagram illustrating the operating device according to the embodiment.

FIG. 2B is a block diagram illustrating a mobile terminal.

FIG. 2C is a block diagram illustrating a vehicle local area network (LAN) to which the operating device is connected.

FIG. 3A is a schematic diagram illustrating the mobile terminal.

FIG. 3B is a schematic diagram illustrating a display screen of an auxiliary display device installed in a vehicle.

FIG. 3C is a schematic diagram illustrating a heads-up display installed in a vehicle.

FIG. 4A is a schematic diagram illustrating a display image displayed in the heads-up display by the operating device according to the embodiment.

FIG. 4B is a schematic diagram illustrating a display image displayed in the auxiliary display device.

FIG. 4C is a schematic diagram illustrating an operating surface of a touchpad.

FIG. 5 is a flowchart illustrating operations performed by the operating device according to the embodiment.

### DESCRIPTION OF EMBODIMENTS

### Summary of Embodiments

An operating device according to an embodiment includes: a communicator that communicates with an electronic device serving as an operation target; a display controller that obtains a first display image displayed by the electronic device through the communicator and outputs, to a display device installed in a vehicle, display control information that causes a second display image based on the obtained first display image to be displayed; an operation detector, disposed in a steering wheel of the vehicle, that outputs detection information based on a detection of an operation made on an operating surface; and a controller that generates operation information on the basis of the detection information obtained from the operation detector and outputs the operation information to the electronic device.

According to this operating device, the second display image, which is based on the first display image displayed by the electronic device, is displayed in the display device, and the operation detector that can operate the electronic device is disposed in the steering wheel; accordingly, movement of the line of sight of an operator can be reduced and operability can be improved.

### Embodiment

### (Overall Configuration of Operating Device 1)

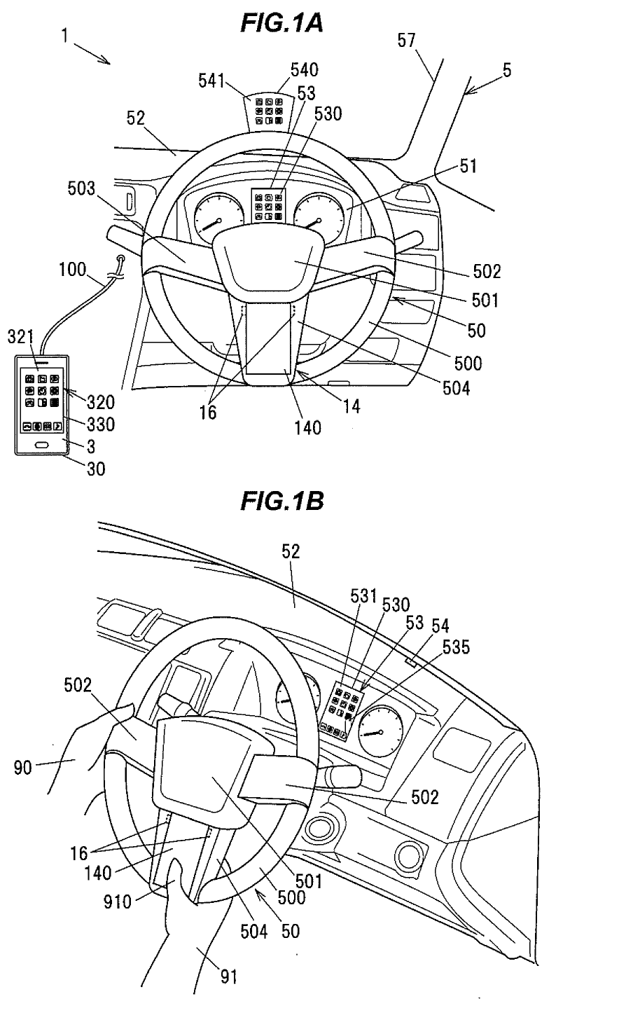

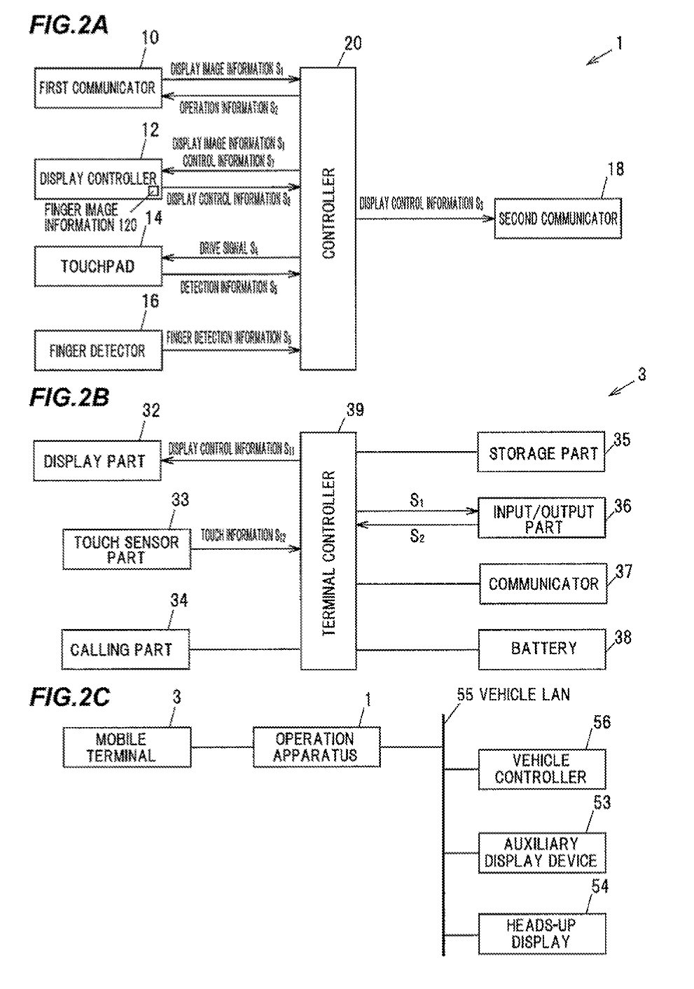

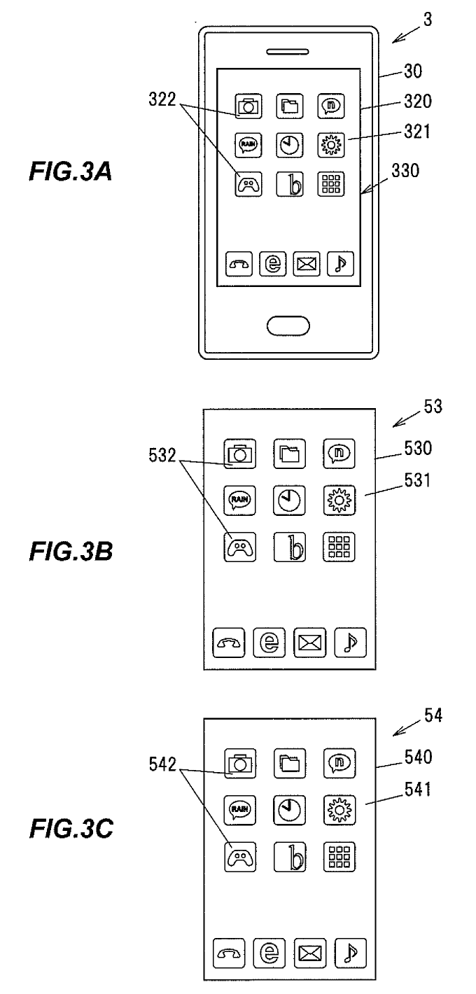

FIG. 1A is a schematic diagram illustrating the interior of a vehicle in which an operating device according to an embodiment is installed, and FIG. 1B is a schematic diagram illustrating an operator operating the operating device. FIG. 2A is a block diagram illustrating the operating device according to the embodiment, FIG. 2B is a block diagram illustrating a mobile terminal, and FIG. 2C is a block diagram illustrating a vehicle LAN to which the operating device is connected. FIG. 3A is a schematic diagram illustrating the mobile terminal, FIG. 3B is a schematic diagram illustrating a display screen of an auxiliary display device installed in the vehicle, and FIG. 3C is a schematic diagram illustrating a heads-up display installed in the vehicle.

In the drawings described in the following embodiments, there are cases where ratios between elements indicated in the drawings are different from the actual ratios. In addition, in FIGS. 2A to 2C, arrows indicate the flows of primary signals, information, and the like.

As illustrated in FIGS. 1A and 1B, this operating device 1 is installed in a vehicle 5, and is configured such that an operator can operate the operating device 1 while gripping a steering wheel 50.

In addition, the operating device 1 is configured to display, in a display device installed in the vehicle 5, a display image that is substantially the same as a display image 321 displayed in a mobile terminal 3 serving as an electronic device that is an electromagnetically-connected operation target, or in other words, mirrors the display image 321 of the mobile terminal 3. Furthermore, the operating device 1 is configured to be capable of operating the electromagnetically-connected mobile terminal 3.

“mirror” means, for example, displaying the display image 321 of the mobile terminal 3 in an auxiliary display device 53 and a heads-up display 54 at a resolution matching the resolution of the auxiliary display device 53 and the heads-up display 54. Meanwhile, “electromagnetically-connected” refers to a connection using at least one of a connection by a conductor, a connection by light, which is a type of electromagnetic wave, and a connection by radio waves, which are a type of electromagnetic wave.

Specifically, as illustrated in FIG. 2A, the operating device 1 includes a first communicator 10 that communicates with the mobile terminal 3, a display controller 12 that obtains the display image 321 through the first communicator 10 as a first display image displayed by the mobile terminal 3 and outputs display control information S3 for displaying a second display image based on the obtained display image 321 to the display device installed in the vehicle 5, a touchpad 14 serving as an operation detector that is disposed in the steering wheel 50 of the vehicle 5 and outputs detection information S5 based on detection of an operation made on an operating surface 140, and a controller 20 that generates operation information S2 on the basis of the detection information S5 obtained from the touchpad 14 and outputs the operation information S2 to the mobile terminal 3.

The operating device 1 also includes a finger detector 16 that outputs finger detection information S6 based on detection of an operating finger approaching the operating surface 140, and a second communicator 18.

As illustrated in FIG. 2C, the operating device 1 is electromagnetically connected to a vehicle LAN 55 through the second communicator 18. The auxiliary display device 53, the heads-up display 54, and a vehicle controller 56, for example, are electromagnetically connected to the vehicle LAN 55.

The above-described display device installed in the vehicle 5 refers to, for example, the auxiliary display device 53 and the heads-up display 54, such that a display screen 530 and a display region 540 are located in front of the operator when the operator sits in the driver's seat.

### (Configuration of First Communicator 10)

The first communicator 10 is configured to be capable of wired communication that communicates over a conductor, optical communication that communicates using light, and wireless communication that communicates using radio waves, for example.

As one example, the first communicator 10 is connected to the mobile terminal 3 through wired communication using a connection cord 100, as illustrated in FIG. 1A. In the case where the mobile terminal 3 is configured to be capable of optical communication, the first communicator 10 is connected to the mobile terminal 3 through optical communication, and in the case where the mobile terminal 3 is configured to be capable of wireless communication, the first communicator 10 is connected to the mobile terminal 3 through wireless communication.

The first communicator 10 is primarily configured to obtain display image information S1, which is information of the display image 321 outputted from the mobile terminal 3, and output, to the mobile terminal 3, the operation information S2 outputted from the controller 20.

### (Configuration of Display Controller 12)

The display controller 12 is configured to perform a processing that enables the display image 321 displayed in the mobile terminal 3 to be displayed in the auxiliary display device 53 and the heads-up display 54, for example. The information of this display image 321 is included in the display image information S1 obtained through the first communicator 10 and the controller 20.

The display controller 12 is configured to generate, on the basis of the obtained display image information S1, for example, the display control information S3, which includes information for displaying a display image 531 in the display screen 530 of the auxiliary display device 53 and information for displaying a display image 541 in the display region 540 of the heads-up display 54. The display controller 12 may be configured to send the information for displaying the display image 531 in the display screen 530 and the information for displaying the display image 541 in the display region 540 separately.

The display controller 12 is configured to display a finger image representing the operating finger in the display device along with the second display image on the basis of control information S7 obtained from the controller 20.

This finger image is generated on the basis of finger image information 120 stored in the display controller 12, and is displayed superimposed over the display image of the auxiliary display device 53 and the display image of the heads-up display 54 based on the display image 321 of the mobile terminal 3.

### (Configuration of Touchpad 14)

As illustrated in FIGS. 1 A and 1B, the touchpad 14 is disposed in a lower part of the steering wheel 50 when the steering wheel 50 is in a neutral position. This neutral position is an operating position of the steering wheel 50 used when the vehicle 5 is traveling straight. FIGS. 1A and 1B illustrate a case where the steering wheel 50 is positioned in the neutral position. To rephrase, the touchpad 14 is disposed in an installation part 504 located at six o'clock on the steering wheel 50 when the steering wheel 50 is in the neutral position.

In the steering wheel 50, a ring-shaped grip part 500 is supported by a spoke 502 and a spoke 503 that project from a central part 501. The installation part 504 in which the touchpad 14 is installed is provided below the central portion 501.

Accordingly, as illustrated in FIG. 1B, the touchpad 14 is disposed so that the operating surface 140 can be operated while the operator is gripping the grip part 500 of the steering wheel 50.

The touchpad 14 is a touch sensor that detects a touched position on the operating surface 140 when the operating surface 140 is touched by a part of the operator's body (a finger, for example) or a dedicated pen, for example. The operator can, for example, operate the mobile terminal 3 connected to the first communicator 10 by operating the operating surface 140. A known resistive film-type, infrared-type, surface acoustic wave (SAW)-type, or electrostatic capacitance-type touchpad can be used as the touchpad 14, for example.

The touchpad 14 according to the present embodiment is an electrostatic capacitance-type touchpad that detects changes in current in inverse proportion to a distance between a finger and a sensor wire produced when the finger approaches the operating surface 140, for example. Although not illustrated in the drawings, a plurality of such sensor wires are provided below the operating surface 140.

The operating surface 140 includes a coordinate system that takes the upper-left of the drawing in FIG. 1A as its origin. The operating surface 140 configures an absolute operation system along with a display screen 320 of the mobile terminal 3, the display screen 530 of the auxiliary display device 53, and the display region 540 of the heads-up display 54.

This absolute operation system is an operation system in which the operating surface 140 corresponds one-to-one with the display screen 320, the display screen 530, and the display region 540.

The touchpad 14 is configured to periodically scan the sensor wires and read out an electrostatic capacitance on the basis of a drive signal S4 outputted from the controller 20. The touchpad 14 is configured to determine whether or not a finger has made contact on the basis of the read-out electrostatic capacitance and, in the case where the finger has been detected, output the detection information S5 including information of the coordinates where the finger has been detected.

### (Configuration of Finger Detector 16)

The finger detector 16 is configured to detect the position of a finger that has approached the operating surface 140, or in other words, the position of the finger before the finger makes contact with the operating surface 140. As one example, the finger detector 16 is disposed near both side surfaces of an upper portion of the touchpad 14, in the drawing indicated in FIG. 1A.

This finger detector 16 includes, for example, an ultrasonic sensor that uses a transmitter to emit ultrasonic waves toward a target object and detects whether or not the target object is present, a distance to the target object, and the like by receiving ultrasonic waves reflected by the target object using a receiver. The finger detector 16 is not limited to an ultrasonic sensor, however, and may be configured to detect the position of the finger by capturing an image of a region including the operating surface 140 and processing the captured image.

The finger detector 16 is configured to generate the finger detection information S6 on the basis of the finger detection and output that information to the controller 20. This finger detection information S6 includes information of coordinates on the operating surface 140 where the approach of the finger has been detected.

### (Configuration of Second Communicator 18)

The second communicator 18 connects to the vehicle LAN 55 and is configured to exchange various types of information with the auxiliary display device 53, the heads-up display 54, the vehicle controller 56, and the like. The controller 20 outputs the display control information S3 to the auxiliary display device 53 and the heads-up display 54 through the second communicator 18 and the vehicle LAN 55.

### (Configuration of Controller 20)

The controller 20 is, for example, a microcomputer includes a central processing unit (CPU) that carries out computations, processing, and the like on obtained data in accordance with stored programs, a random access memory (RAM) and a read only memory (ROM) that are semiconductor memories, and the like. A program for the operation of the controller 20, for example, are stored in the ROM. The RAM is used as a memory region that temporarily stores computation results and the like, for example. The controller 20 also includes an internal means for generating a clock signal, and operates on the basis of this clock signal.

The controller 20 is configured to generate the drive signal S4 for driving the touchpad 14 on the basis of the clock signal and output the drive signal S4.

The controller 20 is also configured to generate the operation information S2 on the basis of the detection information S5 obtained from the touchpad 14 and output the operation information S2 to the mobile terminal 3 through the first communicator 10.

### (Configuration of Mobile Terminal 3)

The mobile terminal 3 is, for example, an electronic device in which desired operations can be executed by touching a display screen, such as a multi-function mobile telephone (a smartphone), a tablet terminal, a music player, or a video player. The mobile terminal 3 according to the present embodiment is a multi-function mobile telephone, for example.

As illustrated in FIG. 3A, the mobile terminal 3 includes an oblong rectangular-shaped main body 30. The mobile terminal 3 is configured so that a desired operation can be carried out by the operator touching an operating surface 330 that is exposed on the front surface of the mobile terminal 3.

As illustrated in FIG. 3A, the mobile terminal 3 has the display screen 320, which is substantially the same size as the operating surface 330, and a plurality of icons 322, which are images to which functions are assigned, are displayed in matrix form in the display screen 320.

As illustrated in FIG. 2B, the mobile terminal 3 includes, for example, a display part 32 having the display screen 320, a touch sensor part 33, a calling part 34, a storage part 35, an input/output part 36, a communicator 37, and a battery 38.

The display part 32 includes a liquid-crystal display, for example. In the mobile terminal 3, the touch sensor part 33 is disposed so as to be overlaid on the liquid-crystal display.

The touch sensor part 33 is, for example, an electrostatic capacitance-type touch sensor disposed beneath the operating surface 330 so that a plurality of transparent electrodes formed from indium tin oxide (ITO) or the like intersect. Accordingly, the mobile terminal 3 is configured so that the operator can view the display screen 320 displayed in the display part 32 through the touch sensor part 33.

The display part 32 and the touch sensor part 33 are configured so that the display screen 320 and the operating surface 330 have substantially the same size and overlap. Here, the touch sensor part 33 may be an in-cell type touch sensor integrated with the display part 32.

The calling part 34 has a function that enables voice calls to be made with another electronic device, for example. The storage part 35 stores music files, video files, applications, and the like.

The input/output part 36 is configured to connect to the connection cord 100 illustrated in FIG. 1A and input/output various types of information, and to be capable of transmitting power used to charge the battery 38.

The communicator 37 is configured to be capable of connecting to a wireless communication network, for example. The battery 38 is a lithium ion battery, for example, and is configured to supply power required by the mobile terminal 3 to operate.

A terminal controller 39 is, for example, a microcomputer includes a CPU that carries out computations, processing, and the like on obtained data in accordance with stored programs, a RAM and a ROM that are semiconductor memories, and the like. Programs for operations of the terminal controller 39, for example, are stored in the ROM. The RAM is used as a memory region that temporarily stores computation results and the like, for example. The terminal controller 39 also includes an internal means for generating a clock signal, and operates on the basis of this clock signal.

The terminal controller 39 is configured, for example, to obtain, through the input/output part 36, the operation information S2 outputted from the operating device 1, and execute functions based on the obtained operation information S2, as well as generate display control information S11 for controlling the display part 32 and output the display control information S11 to the display part 32.

The terminal controller 39 is also configured, for example, to execute functions based on touch information S12 obtained from the touch sensor part 33, as well as generate the display control information S11 for controlling the display part 32 and output the display control information S11 to the display part 32.

The terminal controller 39 is configured to generate the display image information S1 on the basis of the display control information S11 for controlling the display part 32, and output the display image information S1 to the operating device 1 through the input/output part 36 and the connection cord 100.

### (Configuration of Vehicle 5)

As illustrated in FIG. 2C, the vehicle 5 includes the auxiliary display device 53, the heads-up display 54, and the vehicle LAN 55.

The auxiliary display device 53 is, for example, a liquid-crystal display disposed between instruments in an instrument cluster 51. These instruments may be images displayed in a liquid-crystal display, or may be mechanical instruments.

The auxiliary display device 53 is configured, for example, to display the same image as the display image 321 of the mobile terminal 3, or in other words, to mirror the mobile terminal 3, on the basis of the display control information S3 obtained through the operating device 1 and the vehicle LAN 55.

Accordingly, as illustrated in FIGS. 3A and 3B, a plurality of icons 532 corresponding to the plurality of icons 322 of the mobile terminal 3 are displayed in matrix form in the display screen 530 of the auxiliary display device 53.

As illustrated in FIG. 1B, the heads-up display 54 is disposed in an instrument panel 52 near a windshield 57. The heads-up display 54 is an image projector that projects an image onto the windshield 57. In FIG. 1A, the image is projected onto a curved part of the windshield 57, and thus the display region 540 has a fan shape.

The heads-up display 54 is configured, for example, to mirror the mobile terminal 3 on the basis of the display control information S3 obtained through the operating device 1 and the vehicle LAN 55.

Accordingly, as illustrated in FIGS. 3A and 3C, a plurality of icons 542 corresponding to the plurality of icons 322 of the mobile terminal 3 are displayed in matrix form in the display region 540 of the heads-up display 54.

The vehicle LAN 55 is, for example, a network provided so that electromagnetically-connected electronic devices can freely exchange information and the like. As illustrated in FIG. 2C, the operating device 1, the auxiliary display device 53, and the heads-up display 54, for example, are electromagnetically connected to the vehicle LAN 55. The vehicle LAN 55 is configured so that, for example, electronic devices such as a navigation device that displays the current location of the vehicle 5, displays map images, and the like, a music player that plays back music, and an air conditioning device that adjusts the temperature of air inside the vehicle can be connected thereto.

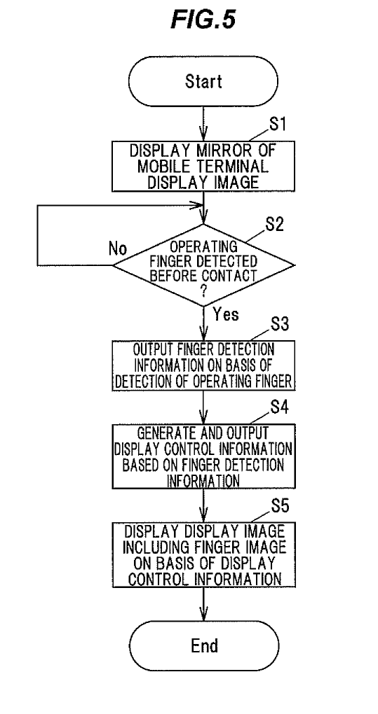

Next, operations performed by the operating device 1 according to this embodiment for displaying a finger image superimposed on a mirrored display image on the basis of an operating finger being detected will be described according to the flowchart in FIG. 5, with reference to the other drawings as well. It is assumed here that the mobile terminal 3 is connected to the operating device 1 by the connection cord 100. The following will describe a case where, for example, the operator grips the grip part 500 of the steering wheel 50 with his or her left hand 90 and right hand 91, grips the grip part 500 in the vicinity of the installation part 504 with his or her right hand 91, and operates the touchpad 14 with the thumb of his or her right hand 91 serving as an operating finger 910, for example, as illustrated in FIG. 1B. The operating finger is not limited to the thumb.

### (Operations)

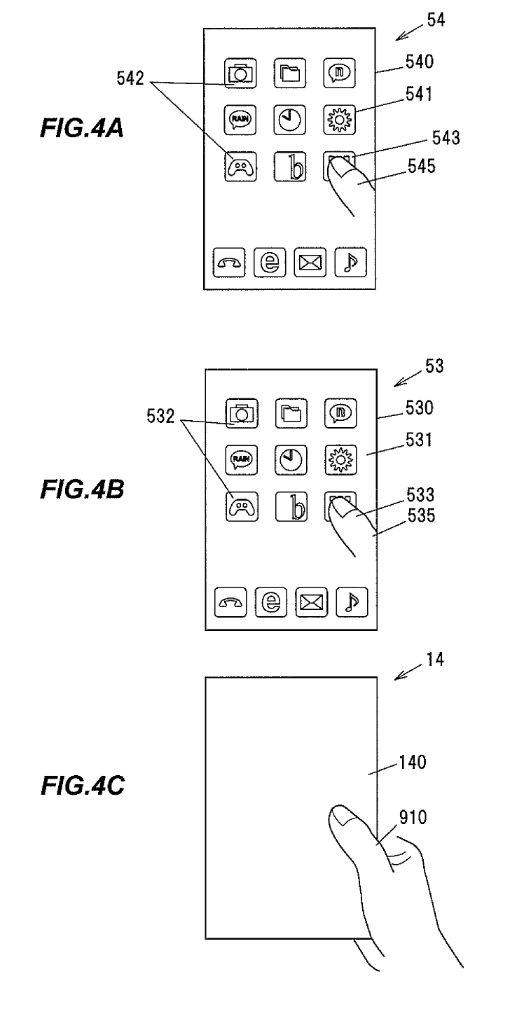

FIG. 4A is a schematic diagram illustrating a display image displayed in the heads-up display by the operating device according to the embodiment, FIG. 4B is a schematic diagram illustrating the display image displayed in the auxiliary display device, and FIG. 4C is a schematic diagram illustrating the operating surface of the touchpad. FIG. 5 is a flowchart illustrating the operations performed by the operating device according to the embodiment.

FIGS. 4A to 4C illustrate the touchpad 14, the display screen 530 of the auxiliary display device 53, and the display region 540 of the heads-up display 54 as being arranged in that order from bottom to top in front of the operator.

First, upon supply of power from the vehicle 5, the controller 20 of the operating device 1 outputs the drive signal S4 to the touchpad 14, and the finger detector 16 detects whether or not the operating finger 910 has approached the operating surface 140.

Meanwhile, the display controller 12 obtains the display image information 51, which is information of the display image 321 of the mobile terminal 3, through the connection cord 100, the first communicator 10, and the controller 20. Next, the display controller 12 generates the display control information S3 for mirroring the display image 321 of the mobile terminal 3 on the basis of the display image information 51, and outputs the display control information S3 to the vehicle LAN 55 through the controller 20 and the second communicator 18.

The auxiliary display device 53 and the heads-up display 54 mirror the display image 321 of the mobile terminal 3 on the basis of the display image information 51 obtained through the vehicle LAN 55, as illustrated in FIGS. 4A and 4B (S1).

Then, while watching the auxiliary display device 53 or the heads-up display 54 in which the display image 321 of the mobile terminal 3 is mirrored, the operator brings his or her operating finger 910 toward the operating surface 140 of the touchpad 14 in order to operate the mobile terminal 3, as illustrated in FIG. 4C.

In the case where this operation made by the operator results in “Yes” in step 2, or in other words, in the case where the finger detector 16 has detected the operating finger 910 prior to contact with the operating surface 140, the finger detection information S6, including information of the coordinates where the finger has been detected, is generated and outputted to the controller 20 (S3).

The controller 20 generates the display control information S3 on the basis of the obtained finger detection information S6 and outputs the display control information S3 (S4).

Specifically, upon obtaining the finger detection information S6, the controller 20 controls the display controller 12 to generate the display control information S3, in which the finger image is superimposed on the display image 321 of the mobile terminal 3. The controller 20 outputs, to the auxiliary display device 53 and the heads-up display 54, the display control information S3 for displaying the finger image in the display image that mirrors the display image 321 of the mobile terminal 3.

Having obtained this display control information S3, the auxiliary display device 53 and the heads-up display 54 display the display image 531 and the display image 541 including the finger image (S5).

Specifically, the auxiliary display device 53 that has obtained the display control information S3 displays the display image 531 including a finger image 535 in the display screen 530, as illustrated in FIG. 4B. Likewise, the heads-up display 54 that has obtained the display control information S3 displays the display image 541 including a finger image 545 in the display region 540, as illustrated in FIG. 4A.

The finger image 535 of the auxiliary display device 53 is displayed, for example, on an icon 533 corresponding to the coordinates on the operating surface 140 where the approach of the operating finger 910 has been detected, as illustrated in FIGS. 4B and 4C.

Likewise, the finger image 545 of the heads-up display 54 is displayed, for example, on an icon 543 corresponding to the coordinates on the operating surface 140 where the approach of the operating finger 910 has been detected, as illustrated in FIGS. 4A and 4C.

Accordingly, the operator can recognize which position in the display image 321 of the mobile terminal 3 the operating finger 910 is located without moving his or her line of sight to the mobile terminal 3.

### Effects of the Embodiment

The operating device 1 according to the present embodiment can improve operability when operating the mobile terminal 3 through the touchpad 14. Specifically, the operating device 1 operates such that the display image 531 and the display image 541, which are mirrors of the display image 321 displayed by the mobile terminal 3, are displayed by the auxiliary display device 53 and the heads-up display 54 located in front of the operator. In addition, the operating device 1 is configured so that the touchpad 14, which can operate the mobile terminal 3, is disposed in the steering wheel 50. Accordingly, the operating device 1 can reduce movement of the line of sight of the operator and improve operability when operating the mobile terminal 3 through the touchpad 14.

In addition, the operating device 1 is configured so that the touchpad 14 is disposed in a position where the operator can operate the touchpad 14 while still gripping the grip part 500 of the steering wheel 50; thus compared to a case where the operator directly operates the mobile terminal, the touchpad 14 can be operated without the operator removing his or her hands from the steering wheel 50, which improves the operability.

In addition, according to the operating device 1, the touchpad 14, the auxiliary display device 53, and the heads-up display 54 are arranged in front of the operator from bottom to top in the case where the steering wheel 50 is located in the neutral position; thus compared to a case where the display devices are located in a position aside from in front of the operator, the operator can make operations with only small movements in his or her line of sight, which improves the operability.

In addition, according to the operating device 1, the finger image is displayed in the mirrored display image; thus compared to a case where the finger image is not displayed, the operator can make operations as if he or she is directly operating the mobile terminal 3, eliminating the need for the operator to remember complicated operations. Accordingly, the operating device 1 provides good operability and high reliability for operations.

In addition, according to the operating device 1, the touchpad 14 is disposed in the center of a lower part of the steering wheel 50 while the steering wheel 50 is in the neutral position, and thus the apparatus provides the same favorable operability regardless of whether the operator uses his or her left or right hand and regardless of whether the steering wheel is on the right or the left side. Accordingly, the operating device 1 provides favorable operability regardless of the specifications of the vehicle, individual differences between operators, and the operator's dominant hand. In addition, in the case where handwriting input is made through the touchpad 14, for example, the operating device 1 enables the operator to make the operation using his or her dominant hand for the above-described reasons, which provides high reliability for operations.

In addition, according to the operating device 1, the touchpad 14 is installed in the installation part 504 that connects the central portion 501 and the grip part 500 of the steering wheel 50, and thus there is a high degree of freedom with respect to the shape and size of the operating surface 140 of the touchpad 14. This is because the installation part 504 is disposed in a position that does not interfere with the operator manipulating the steering wheel 50, and thus there is a high degree of freedom with respect to the shape and size of the installation part 504. Thus according to the operating device 1, in the case where the mobile terminal 3 is a multi-function mobile telephone, for example, the operating surface 140 of the touchpad 14 can be set to a size similar to that of the operating surface 330 of the mobile terminal 3, which enables the operator to operate the touchpad 14 with a similar operability as that of the mobile terminal 3.

Furthermore, according to the operating device 1, the touchpad 14 is disposed in the steering wheel 50, and thus the operator can hold the touchpad 14 with his or her hand on the steering wheel 50, which enables the operator to make operations in a stable manner.

The display devices that mirror the mobile terminal 3 are not limited to the auxiliary display device 53 and the heads-up display 54. In addition, there may be more than two display devices.

In addition, the operating device 1 may be configured to connect directly to a display device rather than connecting over the vehicle LAN 55, for example.

The operating device 1 according to the above-described embodiment and variations is partially implemented by a program executed by a computer, an application specific integrated circuit (ASIC), a field programmable gate array (FPGA), or the like in accordance with the use of the apparatus, for example.

An ASIC is an integrated circuit customized for a particular use, and an FPGA is a programmable large scale integration (LSI) circuit.

Although several embodiments and variations of the present invention have been described above, these embodiments and variations are merely examples, and the invention according to claims is not to be limited thereto. Novel embodiments and variations thereof can be implemented in various other forms, and various omissions, substitutions, changes, and the like can be made without departing from the spirit and scope of the present invention. In addition, all combinations of the features described in these embodiments and variations are not necessarily needed to solve the technical problem. Furthermore, these embodiments and variations are included within the spirit and scope of the invention and also within the invention described in the claims and the scope of equivalents thereof.

### REFERENCE SIGNS LIST

1 Operating Device
3 Mobile Terminal
5 Vehicle
10 First Communicator
12 Display Controller
14 Touchpad
16 Finger Detector
18 Second Communicator
20 Controller
30 Main Body
32 Display Part
33 Touch Sensor Part
34 Calling Part
35 Storage Part
36 Input/Output Part
37 Communicator
38 Battery
39 Terminal Controller
50 Steering Wheel
51 Instrument Cluster
52 Instrument Panel (Dashboard)
53 Auxiliary Display Device
54 Heads-Up Display
55 Vehicle Lan
56 Vehicle Controller
57 Windshield
90 Left Hand
91 Right Hand
100 Connection Cord
120 Finger Image Information
140 Operating Surface
320 Display Screen
321 Display Image
322 Icon
330 Operating Surface
500 Grip Part
501 Central Part
502 Spoke
503 Spoke
504 Installation Part
530 Display Screen
531 Display Image
532 Icon
533 Icon
535 Finger Image
540 Display Region
541 Display Image
542 Icon
543 Icon
545 Finger Image
910 Operating Finger

1. An operating device, comprising:
a communicator that communicates with an electronic device serving as an operation target;
a display controller that obtains a first display image displayed by the electronic device through the communicator and outputs, to a display device installed in a vehicle, display control information that causes a second display image based on the obtained first display image to be displayed;
an operation detector disposed in a steering wheel of the vehicle, the operation detector being configured to output a detection information based on a detection of an operation made on an operating surface thereof; and
a controller that generates an operation information on the basis of the detection information obtained from the operation detector and outputs the operation information to the electronic device.

2. The operating device according to claim 1, wherein the operation detector comprises a finger detector that outputs a finger detection information based on a detection of an operating finger approaching the operating surface, and
wherein the display controller displays a finger image representing the operating finger in the display device along with the second display image on the basis of the finger detection information obtained from the finger detector.

3. The operating device according to claim 1, wherein the operation detector is disposed in a lower part of the steering wheel when the steering wheel is in a neutral position.

4. The operating device according to claim 1, wherein the display device comprises at least one of an auxiliary display device disposed in an instrument cluster of the vehicle and an image projector that projects an image onto a windshield of the vehicle.

5. The operating device according to claim 1, wherein the operation detector comprises a touchpad.

6. The operating device according to claim 1, wherein the electronic device comprises an electronic device that includes a display screen and executes a desired operation in response to the operating finger making contact with the display screen.

7. The operating device according to claim 1, wherein the operation detector comprises a touchpad affixed between a central portion and a grip portion of the steering wheel.
